(19) United States
(12) Patent Application Publication
(10) Pub. No.: US 2008/0081144 A1
(43) Pub. Date: Apr. 3, 2008

(54) Soft plastic "origami" block

(75) Inventor: Yasuyuki Kato, Nishitokyo-Shi (JP)

Correspondence Address: BACON & THOMAS, PLLC, 625 SLATERS LANE, FOURTH FLOOR, ALEXANDRIA, VA, 22314, US

(73) Assignee: RAIKODO, Nishitokyo-Shi (JP)

(21) Appl. No.: 11/641,098

(22) Filed: Dec. 19, 2006

(30) Foreign Application Priority Data
Dec. 19, 2005 (JP) U2005-010751

(51) Int. Cl. B32B 3/00; B29D 31/00

(52) U.S. Cl. 428/57; 264/152

(57) ABSTRACT

A soft plastic “origami” block comprised of an isosceles triangle shaped soft plastic first sheet on one surface of which two isosceles triangle shaped soft plastic second sheets are symmetrically arranged across a vertical bisector of a bottom side of the soft plastic first sheet, wherein outer edges of the soft plastic second sheets are melt fused to outer edges of the soft plastic first sheet, the outer surfaces of the two soft plastic second sheets and soft plastic first sheet form two tapered insert legs and the insides form tapered insert slots smaller than the insert legs, and the remaining not melt fused single sides of the two soft plastic second sheets and the soft plastic first sheet form an insert opening connecting to the insert slots and also an “origami” block assembly using the same.

### BACKGROUND OF THE INVENTION

1. Field of the Invention

The present invention relates to a soft plastic “origami” block used when forming a construct of an animal, person, bird, or other organism, or a building, an imaginary monster, or other various types of constructs or a toy or piece of interior décor etc. by assembly small blocks, a method of production of the same, and a soft plastic “origami” block assembly using the same.

2. Description of the Related Art

Origami is a traditional Japanese handicraft. A large number of sheets of origami paper may be used to create various works of art. Origami paper is sometimes folded to create three-dimensional substantially triangular shaped parts (paper “origami” blocks, hereinafter also referred to as just “‘origami’ blocks”). A large number of such “origami” blocks are then assembled to form the body part and head part of a construct, then limbs, tails, features, etc. are attached to thereby create a toy or interior decoration or other various types of assemblies. (See Block Origami, Nitto Shoin, Apr. 2, 2004).

As such an “origami” block, the “origami” block 35 such as shown in FIGS. 15A and 15B is known. The “origami” block 35 is an “origami” block made by precisely folding colored paper. Folding a large number of sheets of origami paper is extremely time consuming. As is well known, long patient work is required.

When building some construct using such precisely folded “origami” blocks 35, for example as shown in FIG. 16 and FIG. 17, one makes a large number of “origami” blocks 35, arranges a number of these in a circle to form a lower level of “origami” blocks 35, inserts an upper level of “origami” blocks 35 into the lower level while using an adhesive to bond them, and continues building further higher levels upward so as to form a body part 23 or head part 27, then adds legs 30, arms 28, ears 32, a tail, etc. to form an “origami” block assembly 31a representing a stylized “pocket monster”.

Explaining this more specifically, the folding procedure when making such an “origami” block 35 is as follows: First, as shown in FIG. 14A, one folds a rectangular sheet of colored paper 36 along the folding line 37 bisecting the sheet in the width direction and extending in the longitudinal direction as shown in FIG. 14B so that the colored side becomes the outside. Next, as shown in FIG. 14C, one makes creases 39 along the vertical folding lines 38 dividing the left-right direction into four equal parts so as to enabling later folding and provides slanted folding lines 41 in the diagonal direction of each of the four equal parts so as to alternate in slant direction. One then bends the end triangular regions 40 at the bottoms of the left and right ends to the front (toward the viewer) to obtain the inverted trapezoid shape as shown in FIG. 14D. Next, as shown on FIG. 14E, one folds the two ends downward along the slanted folding lines 41 to obtain the diamond shape, then further folds the folded bottom end to the back to obtain the “origami” block 35 of the state shown in FIG. 14F. In this state, the block is therefore formed with insert legs 3 and insert slots 4 at the left and right sides.

From the state of FIG. 14F, one then folds the block backward along the center vertical folding line 38, whereby the first basic “origami” block 35 shown in FIG. 14G is formed.

The first basic “origami” blocks 35 are arranged in a circle in the horizontal direction to form one level, and a large number of such levels are stacked in the vertical direction. At this time, the insert legs 3 are coated at their front ends with an adhesive as required and inserted into the insert slots 4. As a result, an “origami” block assembly 31a is formed.

In addition to this, it is possible to form assemblies representing real animals or birds, imaginary animals or plants, or various other stylized objects.

However, all of this requires cold large numbers of sheets of colored paper one by one to make a large number of “origami” blocks 35. Further, there is the problem that trying to form some construct when fabricating an assembly requires tremendous time and effort to be expended.

The fabrication of a large number of “origami” blocks 35 is both monotonous and troublesome. It would therefore be desirable to eliminate this part of the work and enable time and energy to be focused on the design of the construct.

Further, the above “origami” blocks were made of paper. Therefore, when trying to make a change in a location fastened by an adhesive etc., the blocks were liable to tear. Further, only single use was possible. The blocks could not be used a plurality of times. Further, they were not durable.

Further, when using colored paper to make “origami” blocks, there is little semitransparent colored paper, so there was the problem that there was not much freedom of color design.

### SUMMARY OF THE INVENTION

An object of the present invention is to provide a soft plastic “origami” block eliminating the need for paper to be folded one sheet at a time a plurality of times and further having durability and enabling energy to be focused into the design of a construct, a method of production of the same, and a soft plastic “origami” block assembly using the same.

According to a first aspect of the invention, there is provided a soft plastic “origami” block comprised of an isosceles triangle shaped soft plastic first sheet 1 on one surface of which two isosceles triangle shaped soft plastic second sheets 2 are symmetrically arranged across a vertical bisector of a bottom side of the soft plastic first sheet 1, wherein outer edges of the soft plastic second sheets 2 are melt fused to outer edges 2 of the soft plastic first sheet 1, the outer surfaces of the two soft plastic second sheets and soft plastic first sheet 1 form two tapered insert legs 3 and the insides form tapered insert slots 4 smaller than the insert legs 3, and the remaining not melt fused single sides of the two soft plastic second sheets 2 and the soft plastic first sheet 1 form an insert opening 5 connecting to the insert slots 4.

According to the first aspect of the invention, the isosceles triangle shaped soft plastic first sheet 1 has soft plastic second sheets arranged symmetrically on it and melt fused with it at their edges to form a plastic “origami” block of a simple structure with insert slots and insert legs. Further, since this block is made not by paper, but by soft plastic, compared with paper, there is little fear of tearing and the block can be folded without the fear of breakage etc.

Further, complicated folding work like with origami paper is not required, so the time of the manual folding work can be eliminated and the equivalent of that work time can be used for designing the construct.

Further, according to second aspect of the invention, there is provided a soft plastic “origami” block of the first aspect of the invention wherein the insert slots 4 are provided shaped corresponding to the insert legs 3.

In the second aspect of the invention, since the insert slots are shaped corresponding to the insert legs, it is possible to insert an insert leg of one plastic “origami” block into an insert slot of another block in an accurate posture relative and possible to make the inserted joint between the blocks reliable.

According to a third aspect of the invention, there is provided a method of production of soft plastic “origami” blocks comprising providing a soft plastic second strip-shaped sheet with separated or separable vertical direction cuts and horizontal direction cuts perpendicularly inserting the same forming boundary parts of soft plastic second sheets, overlaying on the soft plastic second strip-shaped sheet a soft plastic first strip-shaped sheet, and, in that state, cutting and melt fusing the soft plastic strip-shaped second sheet and soft plastic strip-shaped first sheet by a cutting and melt fusing die so that the vertical direction cuts and horizontal direction cuts become the positions of the vertical bisectors of isosceles triangle shaped blocks.

According to the third aspect of the invention, by providing the soft plastic second strip-shaped sheet with separated or separable vertical direction cuts 6 and perpendicularly intersecting horizontal direction cuts, overlaying on this a soft plastic first strip-shaped sheet, and, in that state, cutting these sheets into the shapes of substantially isosceles triangles so that the cuts become the positions of vertical bisectors of the isosceles triangle shaped blocks, it is possible to easily and inexpensively fabricate a large number of soft plastic “origami” blocks in an efficient array and possible to make the die for fabricating these soft plastic “origami” blocks a compact die.

The block assembly of the fourth aspect of the invention is assembled using a large number of soft plastic blocks of the first aspect of the invention.

According to the fourth aspect of the invention, compared with an “origami” block assembly using conventional colored paper, there is provided a soft plastic “origami” block assembly using a large number of soft plastic blocks, so the “origami” block assembly is superior in the quality, color, transparency, and beauty of the assembly. Further, such a soft plastic “origami” block assembly can be easily fabricated in a short time.

### BRIEF DESCRIPTION OF THE DRAWINGS

These and other objects and features of the present invention will become clearer from the following description of the preferred embodiments given with reference to the attached drawings, wherein:

FIG. 1A is a front view showing a soft plastic “origami” block of a first embodiment of the present invention, FIG. 1B is a cross-sectional view along the line I-I of FIG. 1A, and FIG. 1C is an enlarged view of part of FIG. 1B,

FIG. 2A is a front view of a soft plastic “origami” block of another embodiment of the present invention, while FIG. 2B is a cross-sectional view along the line II-II of FIG. 2A,

FIGS. 3A to 3C show an embodiment of the case of use of the soft plastic “origami” block of the present invention, wherein FIG. 3A is a cross-sectional view of the state folded to overlap, FIG. 3B is a cross-sectional view of the state bent to a state with the legs opened, and FIG. 3C is a perspective view of a soft plastic “origami” block in the folded state,

FIG. 4 is a plan view showing the state with a soft plastic strip-shaped second sheet provided with cuts,

FIG. 5 is a plan view showing an embodiment of a soft plastic strip-shaped sheet,

FIG. 6 is a schematic perspective view showing the state right before overlaying a soft plastic strip-shaped first sheet with a soft plastic strip-shaped second sheet,

FIG. 7 is a bottom view showing an embodiment of a die with blades for forming cuts or cut grooves in the soft plastic second sheet,

FIG. 8A is a cross-sectional view along the line III-III of FIG. 7, FIG. 8B is a cross-sectional view along the line IV-IV of FIG. 7, and FIG. 8C is a cross-sectional view showing the state of providing cuts in a soft plastic sheet,

FIG. 9 is a bottom view of an embodiment of a die with blades used when heating and melt fusing a soft plastic first sheet and a soft plastic second sheet,

FIG. 10A is a cross-sectional view along the line V-V of FIG. 9, while FIG. 10B is a cross-sectional view showing the state with the overlaid soft plastic strip-shaped first and second sheets melt fused and cut by a cutting and melt fusing die,

FIG. 11 is a plan view showing the state right after heating and melt fusing the soft plastic first sheet and soft plastic second sheet and making separation cuts to fabricate a large number of soft plastic “origami” blocks,

FIG. 12 is a schematic perspective view showing the state of using the soft plastic “origami” blocks of the present invention to fabricate an “origami” block assembly,

FIG. 13 is a schematic view of the state of using a plurality of soft plastic “origami” blocks of the present invention to form a tail part etc.,

FIGS. 14A to 14G are plan views showing the routine for fabricating an “origami” block using conventional colored paper,

FIG. 15A is a perspective view of a conventional “origami” block from the front side, while FIG. 15B is a perspective view of a conventional “origami” block from the back side,

FIG. 16 is a perspective view of an example of an assembly comprised of a large number of conventional “origami” blocks used assembled together, and

FIG. 17 is a perspective view of the assembly shown in FIG. 16 from the bottom side.

### DESCRIPTION OF THE PREFERRED EMBODIMENTS

Next, the present invention will be explained in detail based on the illustrated embodiments.

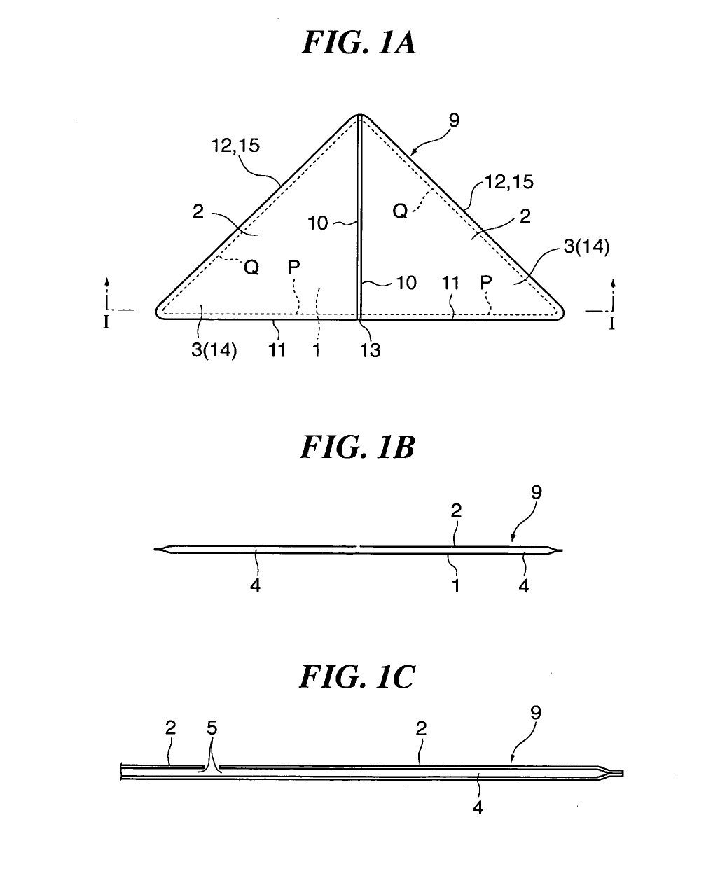

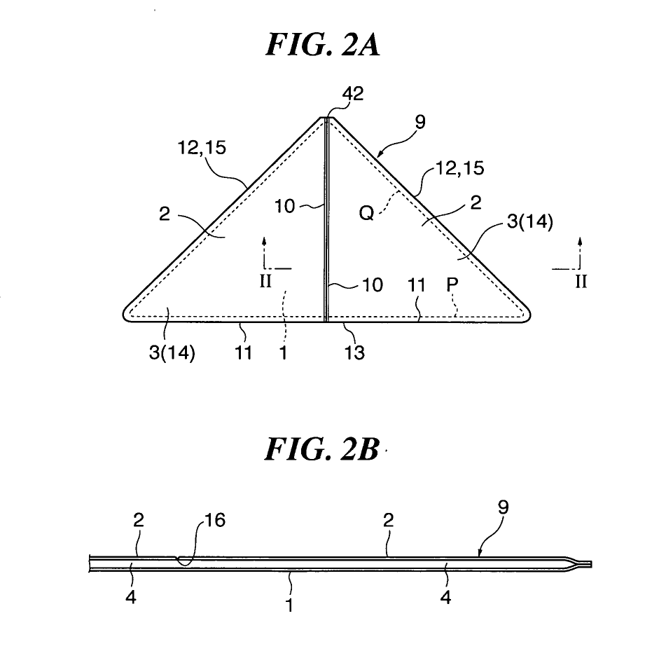

FIGS. 1A to 1C and FIGS. 2A and 2B show a first embodiment and second embodiment of a soft plastic “origami” block 9 of the present invention. Each is comprised of a substantially isosceles triangle-shaped soft plastic first sheet 1, arranged at the bottom side, on one surface of which (top surface) isosceles triangle-shaped soft plastic second sheets 2 are arranged symmetrically about a vertical line segment bisecting a bottom side (long side 13) of that soft plastic first sheet 1 so that single equal sides 10 are positioned at the boundary sides.

Further, the two outer edges of each of the soft plastic second sheets 2, that is, the equal side 11 at the opposite side to the equal side 10 positioned at the boundary side and the long side (bottom) 12, are melt fused to the outer edges of the isosceles triangle-shaped soft plastic first sheet 1. More specifically, the opposite side equal sides 11 of the soft plastic second sheets 2 are arranged positioned at two halves of a long side 13 of the soft plastic first sheet 1, then the side edges (outside parts shown by the dotted lines P) are heated and melt fused, while the long sides 12 of the soft plastic second sheets 2 are arranged positioned at the equal sides 15 of the soft plastic first sheet 1, then the side edges (outside parts shown by the dotted lines Q) are melt fused. The side edges may be melt fused continuously or discontinuously in the longitudinal directions of the sides.

Further, the outsides of the two soft plastic second sheets 2 and the soft plastic first sheet 1 form tapering insert legs 3, and the insides form tapering insert slots 4 smaller than the insert legs 3.

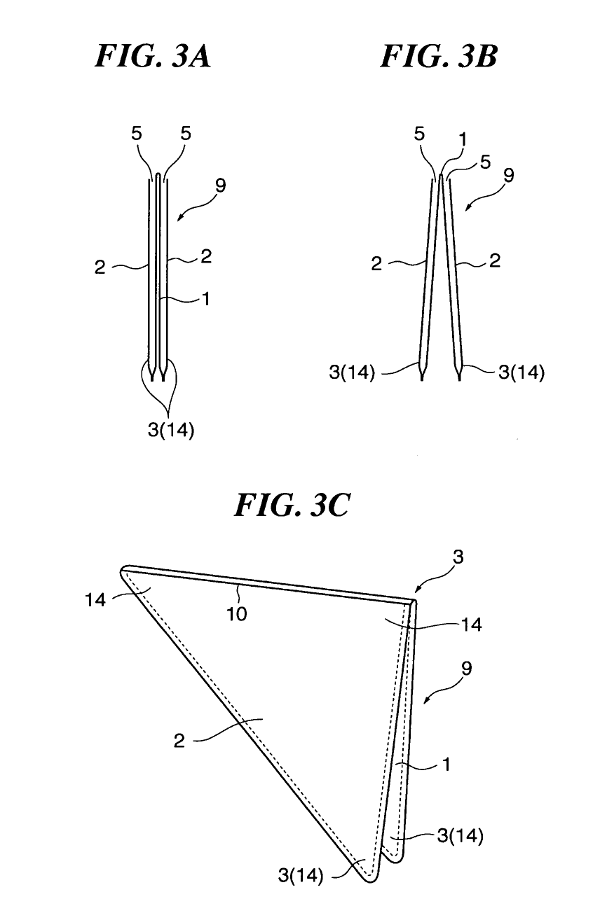

The two left and right side tapering insert legs 3 may independently form insert legs 3. Alternatively, the block may be folded along the vertical bisector to the front or back so that the insert legs 3 overlap and jointly form a single insert leg 3 (see FIG. 3A).

Further, the corner parts of the right angle triangle shape obtained by folding the block along the vertical bisector to the front or back may be utilized as inserts 14 (see FIG. 3C).

Further, the corner parts in FIG. 1A and FIG. 2A may also be utilized as inserts 14 in accordance with need.

Further, the remaining sides (equal sides 10) of the two soft plastic second sheets 2 not melt fused and the soft plastic first sheet 1 form an insert opening 5 connecting to the insert slots 4, whereby a soft plastic “origami” block 9 is formed.

The insert slots 4 have inside shapes similar to the insert legs 3. By making the insert slots 4 shapes smaller than the insert legs 3 and inserting the insert legs 3 into the insert slots 4, the block bulges outward and is given bulk.

By folding the block along the vertical bisector of the soft plastic first sheet so that the two soft plastic second sheets 2 are positioned at the outside or inside of the block, depending on the extent of the folding, it is possible to make a soft plastic “origami” block 9 of overlapped right angle triangle shapes as shown in FIG. 3A or a soft plastic “origami” block 9 in the opened state as shown in FIG. 3B.

FIGS. 2A and 2B show another embodiment wherein two soft plastic second sheets 2 are made able to be later separated by bending a connecting layer 16 forming the boundary parts. By forming he connecting layer 16 forming the boundary parts continuously so as to enable later separation of the two soft plastic second sheets 2, the sheets can be manually separated by a worker while protecting their shapes and therefore the work efficiency can be improved.

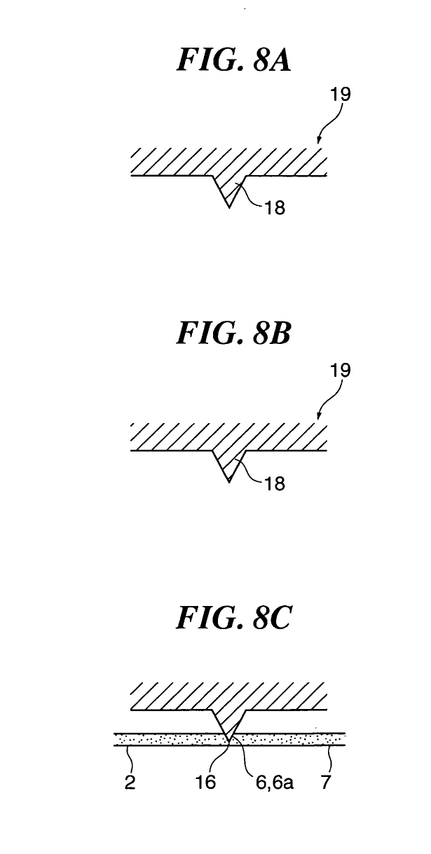

Specifically, as shown enlarged in FIG. 2B or FIG. 8C, if providing a cut 6 at the soft plastic second sheets 2 (or a soft plastic strip-shaped second sheet 7 forming the material for the same) and leaving a connecting layer 16 of a slight thickness able to be easily separated, the sheets can be separated by bending them along that part.

Further, as shown in FIG. 2A, if making the vertex of the soft plastic first sheet 1 a straight chamfered corner part 42 perpendicular to the vertical bisector and providing similar chamfered corner parts at the corner parts of the soft plastic second sheets 2 overlaid on the same in the soft plastic “origami” block 9, when folding the chamfered corner part 42 (see FIG. 3C), the chamfered corner part 42 will not form an acute angle, but will form a flat surface corner part. It will then be possible to eliminate the danger of a corner part of the plastic “origami” block 9 injuring a person. The rest of the configuration is similar to the above embodiment, so similar parts will be assigned similar notations and explanations will be omitted.

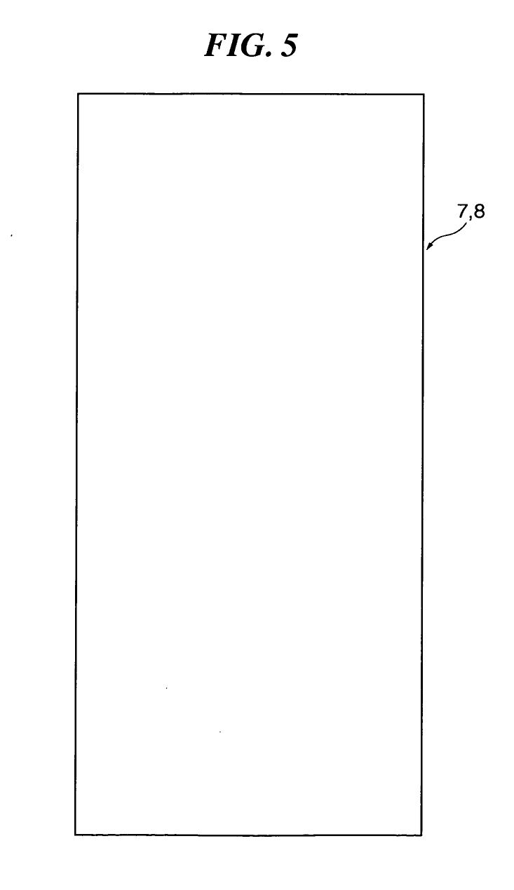

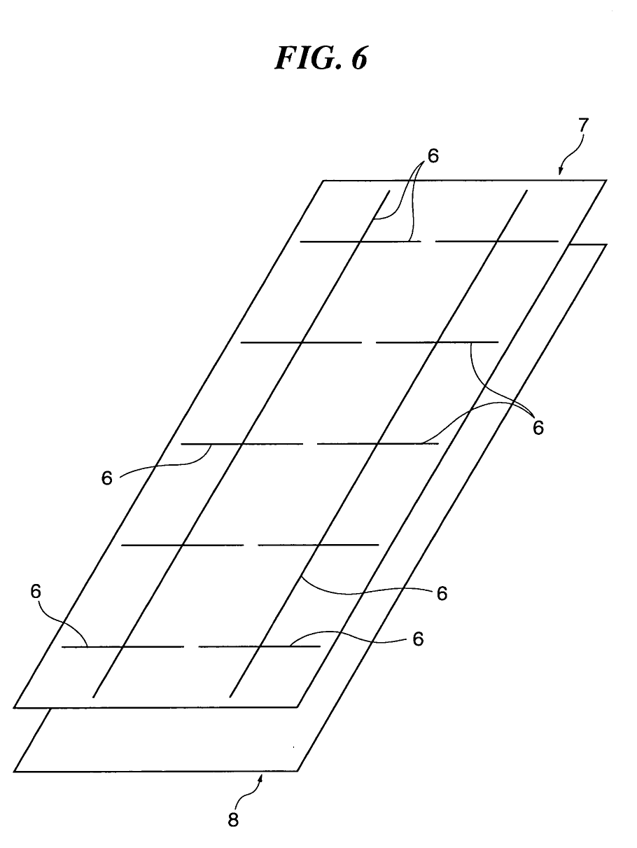

The reason for providing the connecting layer 16 as explained above is that when forming a large number of soft plastic second sheets 2 from a single large sized soft plastic strip-shaped second sheet 7 (see FIG. 5), the sheet like shape of the soft plastic strip-shaped second sheet 7 is held and handling becomes easy for positioning it and overlaying it accurately with the soft plastic strip-shaped first sheet 8 (see FIGS. 5 and 6).

To fabricate the soft plastic strip-shaped sheets 8 and 7 for forming the soft plastic first sheet 1 and the soft plastic second sheets 2 used in the present invention, for example a plasticizer, one or more suitably colored pigment powders, a polyvinyl chloride resin or other plastic, and a stabilizer are mixed, heated to soften, kneaded, then rolled to a sheet shape to thereby form opaque or semitransparent colored soft plastic strip-shaped sheets 8 and 7. For the thickness dimensions of the soft plastic strip-shaped sheets 8 and 7, with long side dimensions of the soft plastic first sheet and second sheets 1 and 2 of 20 mm to 50 mm or so, for example, an around 0.3 mm thickness of sheets may be used. The thickness may be increased or otherwise suitable thickness sheets used as needed in accordance with the size of the soft plastic “origami” block 9.

Next, an embodiment of the method of using the soft plastic strip-shaped first sheet 8 and second sheet 7 to fabricate soft plastic “origami” blocks 9 of the present invention will be explained. In the following embodiment, the blocks are efficiently fabricated by a two-stage method of a first step of making cuts 6 in a soft plastic strip-shaped second sheet 7 and a second step of overlaying the soft plastic strip-shaped second sheet 7 on a soft plastic strip-shaped first sheet 8 and cutting and melt fusing the same.

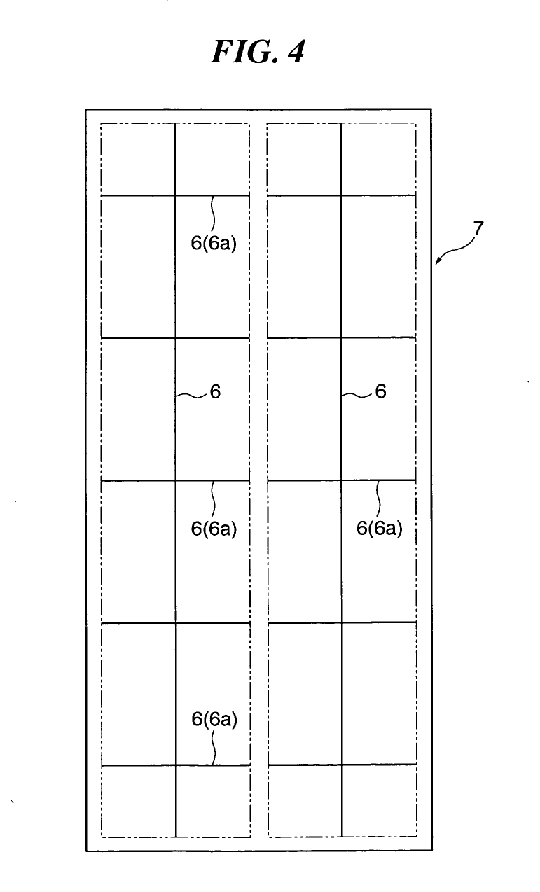

FIG. 4 shows the first stage of dividing the soft plastic strip-shaped second sheet 7 into a large number of sections for forming the soft plastic second sheets 2 of the soft plastic “origami” blocks 9. The soft plastic strip-shaped second sheet 7 is provided with vertical direction cuts 6 running continuously in the longitudinal direction (vertical direction). Perpendicular to the vertical direction cuts 6, a plurality of (in the illustrated case, 5) horizontal direction cuts 6 (6a) extending in the strip width direction are provided in parallel at intervals in the longitudinal direction. If the cuts 6 are made cuts passing through the soft plastic strip-shaped second sheet 7 in the thickness direction, the shape retention property enabling the shape of the sheet to be held is not obtained, so handling is no longer easy. Therefore, it is preferable to leave a slight thickness of a connecting layer 16.

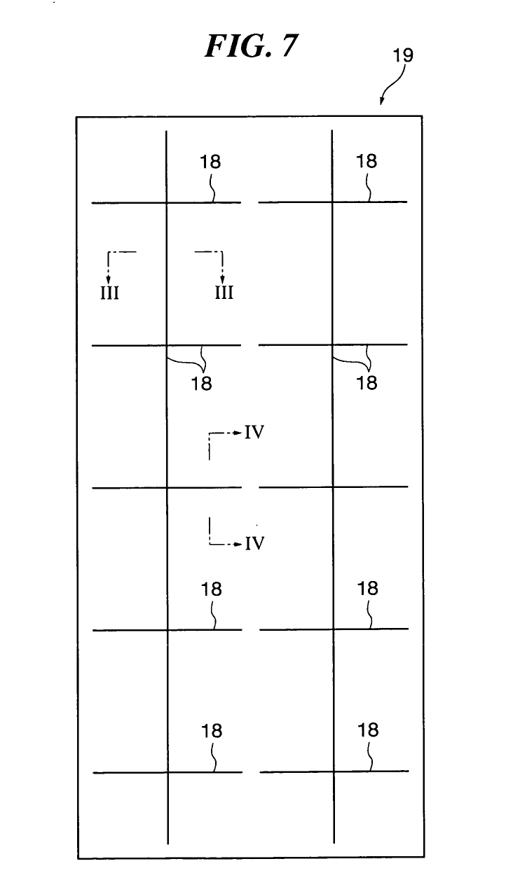

When providing such cuts 6 in the soft plastic strip-shaped second sheet 7, the cuts can be easily formed if using a cut-forming die 19 having a ladder-like array of continuous blades 18 in the vertical direction and the intersecting horizontal direction as shown in the FIG. 7.

After the above soft plastic strip-shaped second sheet 7 is fabricated, the soft plastic strip-shaped second sheet 7 is laid over a soft plastic strip-shaped first sheet 8 of the same size arranged at the bottom side so that the soft plastic strip-shaped second sheet 7 is at the top (see FIG. 6).

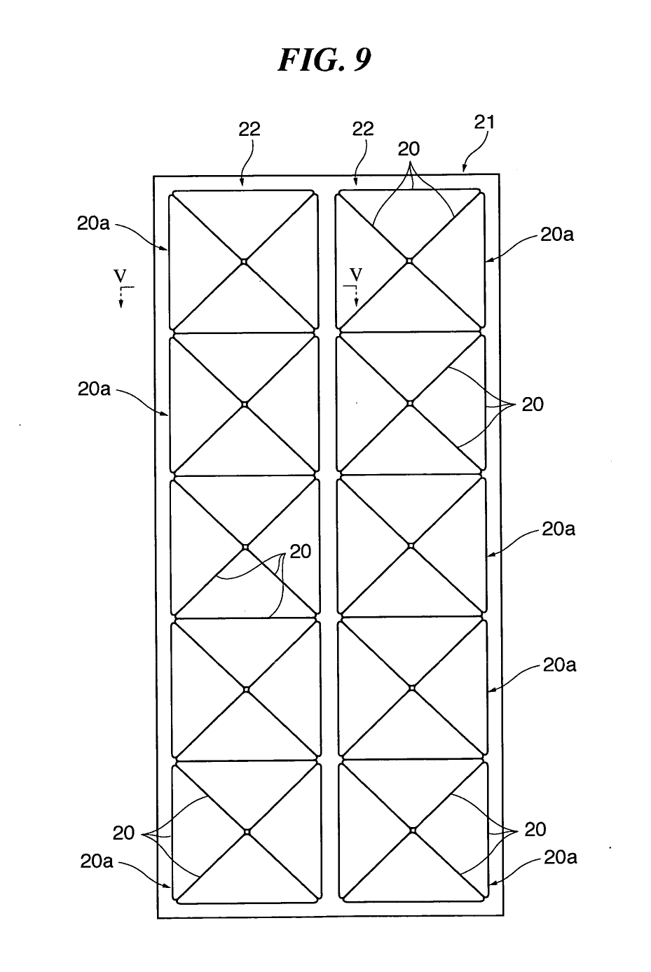

Next, to cut out the soft plastic “origami” blocks 9 from that state, a cutting and melt fusing die 21 having the cutting blades 20 as shown in FIG. 9 and able to cut and melt fuse the sheets is used to cut and melt fuse the sections of the soft plastic strip-shaped first sheet and soft plastic strip-shaped second sheet to thereby fabricate soft plastic “origami” blocks 9.

Next, the configuration of the cutting and melt fusing die 21 will be explained with reference to FIG. 9.

This cutting and melt fusing die 21 is formed with, at its bottom surface, when viewed from the bottom, substantially right angle isosceles triangle shaped cutting and melt fusing blades 20 with arc-shaped corners arranged at 90° equiangular intervals and with boundary parts of the substantially right angle isosceles triangle shaped cutting and melt fusing blades 20 adjoining each other in the horizontal direction sharing cutting and melt fusing blades 20 to form a square shape, thereby forming cutting and melt fusing blades 20a of a square shape with diagonal direction blades in the square; five blocks of such cutting and melt fusing blades 20a of the square shape with diagonal direction blades being provided so that the cutting and melt fusing blades 20a of the square shape with diagonal direction blades form a line and so that boundary parts where the adjoining cutting and melt fusing blades 20a of the square shape with diagonal direction blades adjoin each other in the horizontal direction share cutting and melt fusing blades 20; the five blocks of the cutting and melt fusing blades 20a of the square shape forming the line form one cutting and melt fusing blade column 22; two cutting and melt fusing blade columns 22 being provided.

By arranging the cutting and melt fusing die 21 so that the center axial lines of the cutting and melt fusing blade columns 22 in the longitudinal direction match with the vertical direction cuts 6 provided in the soft plastic strip-shaped second sheet 7, the vertical direction cuts 6 are kept from being severed. Further, the vertical direction cuts 6 are made to form the positions of the vertical bisectors of the cut out soft plastic “origami” blocks 9. Further, the vertical bisectors in the right angle isosceles triangle shaped cutting and melt fusing blades 20 in the width direction of the cutting and melt fusing blade columns 22 are made to form the positions of the vertical bisectors of the cut out soft plastic “origami” blocks 9.

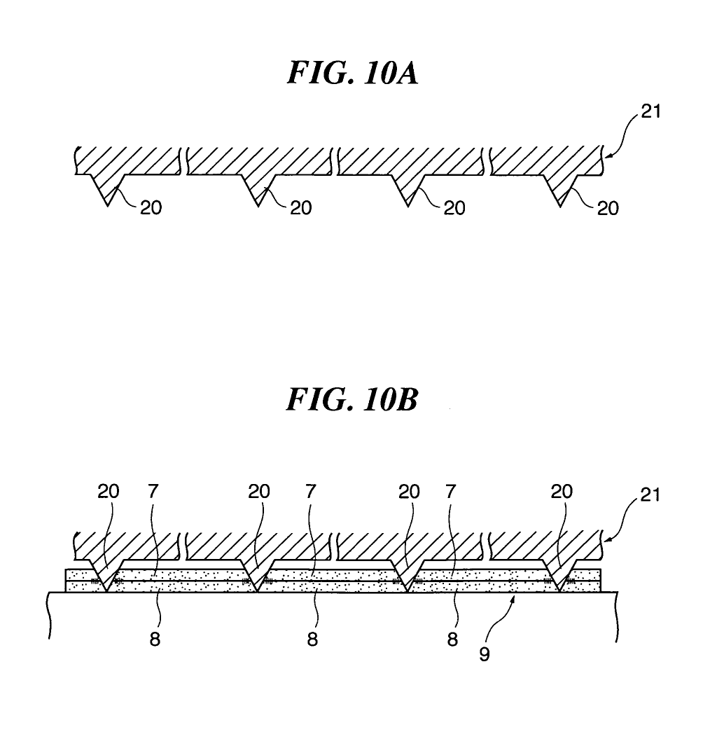

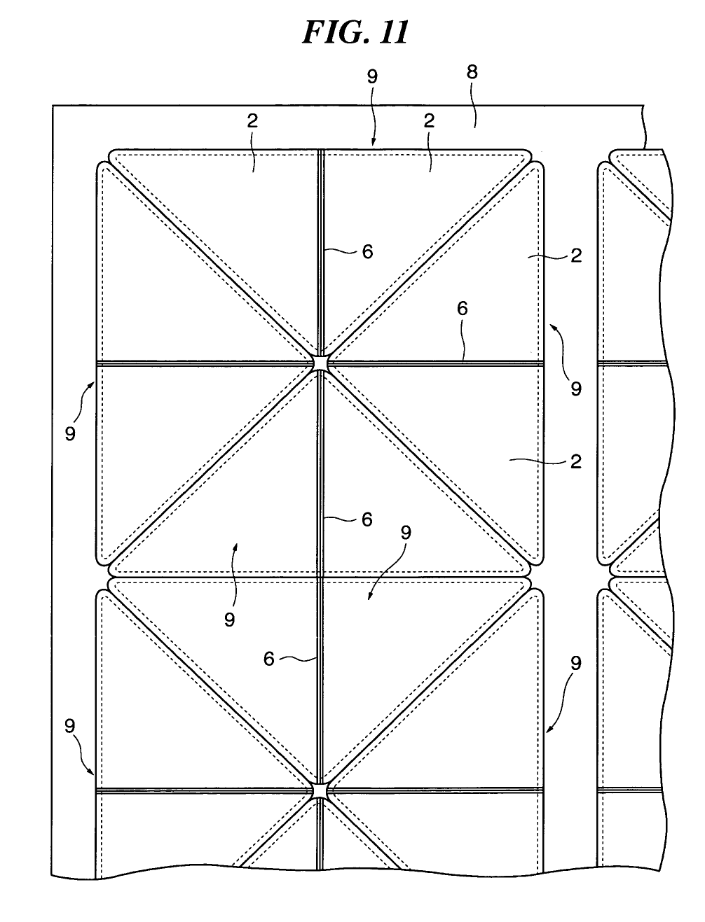

In this way, the cutting and melt fusing die 21 is arranged so that the vertical bisectors of the right angle isosceles triangle shaped cutting and melt fusing blades 20 are positioned over the cuts 6 formed in the soft plastic strip-shaped second sheet 7, and the cutting and melt fusing die 21 is heated by high frequency heating (for example, to a high temperature state of about 160° C.). In that state, as shown in FIG. 10B, the right angle isosceles triangle shaped cutting and melt fusing blades 20 are used to sever the overlaid soft plastic strip-shaped first sheet 8 and soft plastic strip-shaped second sheet 7 to cut out a large number of right angle isosceles triangle shapes. At the same time, the outer edges of the right angle isosceles triangle shapes are melt fused. As a result, right angle isosceles triangle shaped soft plastic “origami” blocks 9 are fabricated.

The thus cut out right angle isosceles triangle shaped soft plastic “origami” blocks 9 are easily manually separated from the soft plastic strip-shaped first sheet 8 and soft plastic strip-shaped second sheet 7 to thereby obtain the soft plastic “origami” blocks 9 shown in FIGS. 1A to 1C or FIGS. 2A and 2B.

Further, the thus fabricated soft plastic “origami” blocks 9 may be bent along the vertical bisectors, that is, along the cuts 6 made in the soft plastic second sheets, so as to easily open up the cuts 6 and thereby form the insert openings 5 and insert slots 4 such as shown in FIGS. 1A to 1C or FIGS. 2A and 2B.

In this way, by providing cuts 6 in the vertical direction and horizontal direction of the soft plastic strip-shaped second sheet 7 and cutting out the blocks by the cutting and melt fusing die 21 SO that these become the positions of the vertical bisectors, four soft plastic “origami” blocks 9 can be fabricated for each intersecting part of the cuts 6 in the vertical direction and horizontal direction and therefore the blocks can be efficiently produced. As another method of fabrication, it is also possible to provide continuous or intermittent cuts 6 in only the vertical direction or only the horizontal direction of the soft plastic strip-shaped second sheet 7 and to cut out the blocks by the cutting and melt fusing die so that these cuts 6 become the positions of the vertical bisectors. Further, it is also possible to arrange two substantially right angle isosceles triangle shaped soft plastic second sheets 2 on a substantially right angle isosceles triangle shaped soft plastic first sheet 1 and melt fuse the outside peripheries to fabricate soft plastic “origami” blocks 9.

Note that the soft plastic “origami” blocks 9 may be made various colored soft plastic “origami” blocks 9 differing in color depth and transparency according to the amounts of pigments contained in the soft plastic strip-shaped first sheet 8 or soft plastic strip-shaped second sheet 7 or the soft plastic strip-shaped first sheet 8 and the soft plastic strip-shaped second sheet 7 may be changed in color balance so as to thereby obtain a plurality of colors of soft plastic “origami” blocks 9.

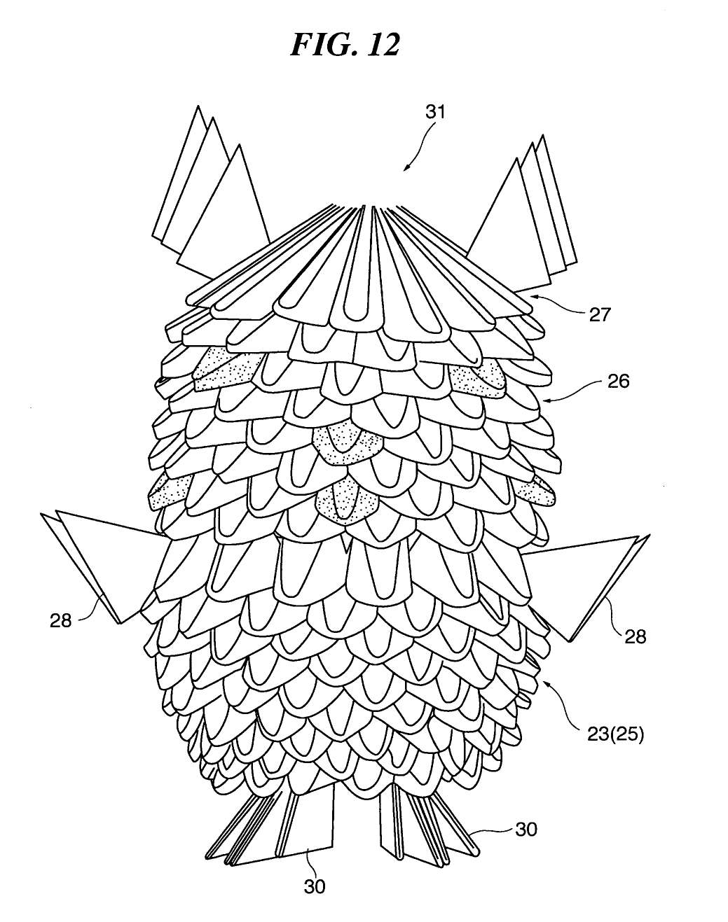

A large number of such soft plastic “origami” blocks 9 may be assembled to form a soft plastic “origami” block assembly 31 such as shown in for example FIG. 12.

As the units for fabricating such an assembly 31, for example, when forming the bottom end of a body part 23 of a circular shape when seen in plan view, soft plastic “origami” blocks 9 are folded so that their insert slots 4 face downward, a large number of the soft plastic “origami” blocks 9 with the thus downward facing insert slots 4 are arranged in a circle to form a bottommost level ring 24, then an insert slot 4 of a second level soft plastic “origami” block 9 in a state rotated 180 degrees horizontally is inserted so as to be inserted over the insert legs 3 at soft plastic “origami” blocks 9 of that bottommost level ring 24 adjoining each other in the horizontal direction, then the insert slots 4 of the succeeding soft plastic “origami” blocks 9 are inserted in the same direction as the above soft plastic “origami” block so as to thereby form the second level ring 25.

That is, the adjoining insert legs 3 of two lower adjoining soft plastic “origami” blocks 9 are straddled by the insert slot 4 of one upper soft plastic “origami” block 9. By alternately inserting upper and lower soft plastic “origami” blocks 9 in this way, it is possible to assemble the rings 25.

Below, the same process is repeated to form the third, fourth, fifth . . . n-th level rings 25. The soft plastic “origami” blocks 9 can therefore form the body part 23 and face part 26.

Further, when assembling the face part 26, soft plastic “origami” blocks 9 of different colors from the colors of the surrounding soft plastic “origami” blocks 9 can be assembled at the parts corresponding to the eyes, nose, mouth, etc.

Note that as an example of the case of forming the top of the head part 27 above the face part 26, the insert slots 4 of the soft plastic “origami” blocks 9 may be inserted over the insert legs 3 of the soft plastic “origami” blocks 9 adjoining each other in the horizontal direction positioned below them to a shallower depth so as to make the top of the head part 27 tapered.

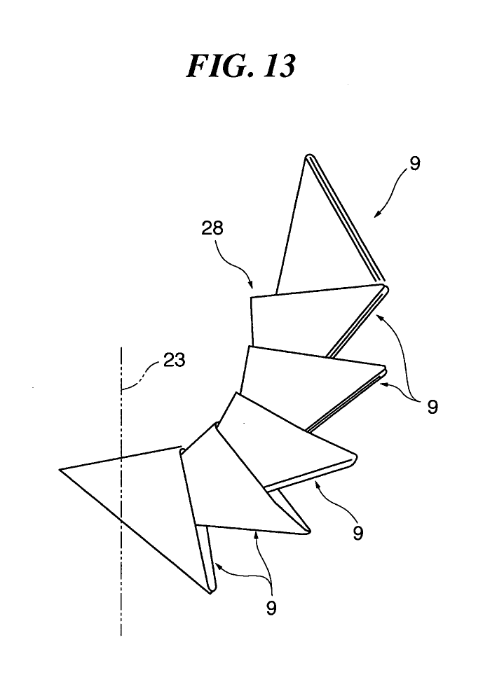

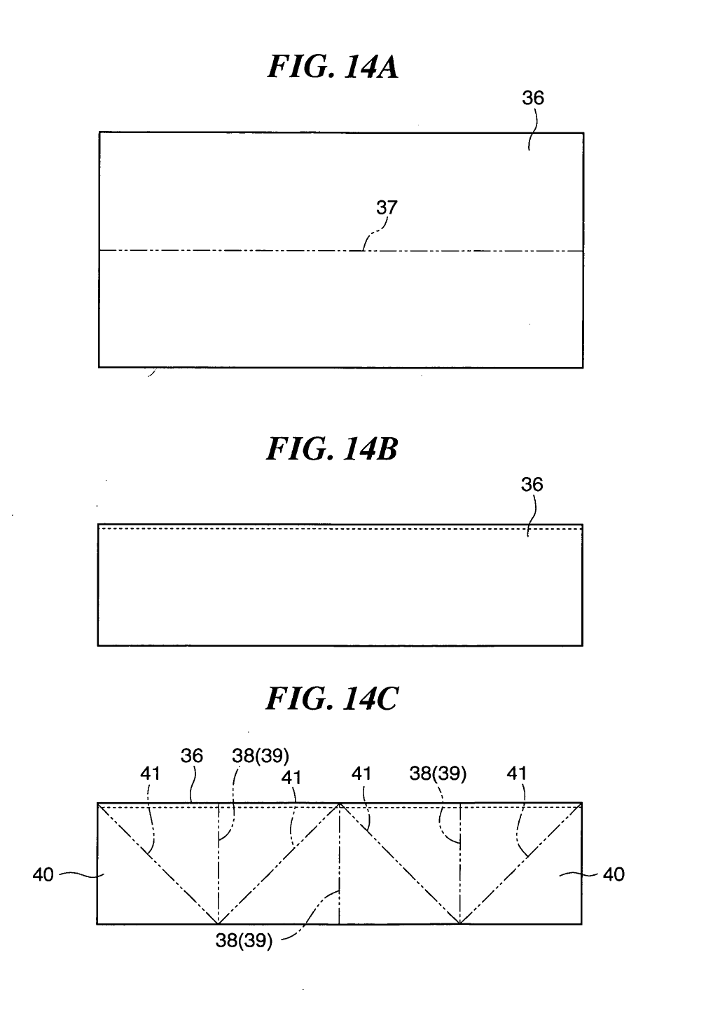

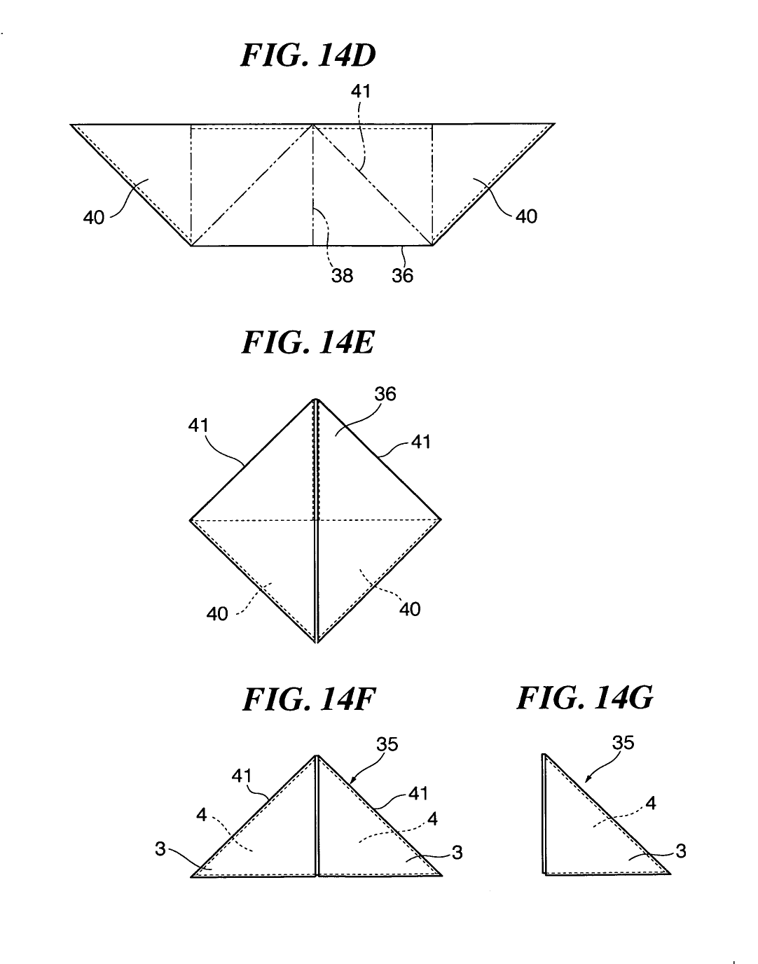

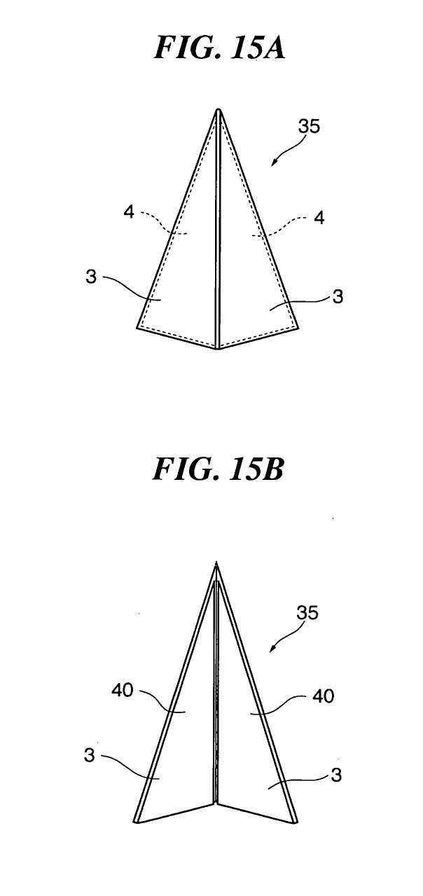

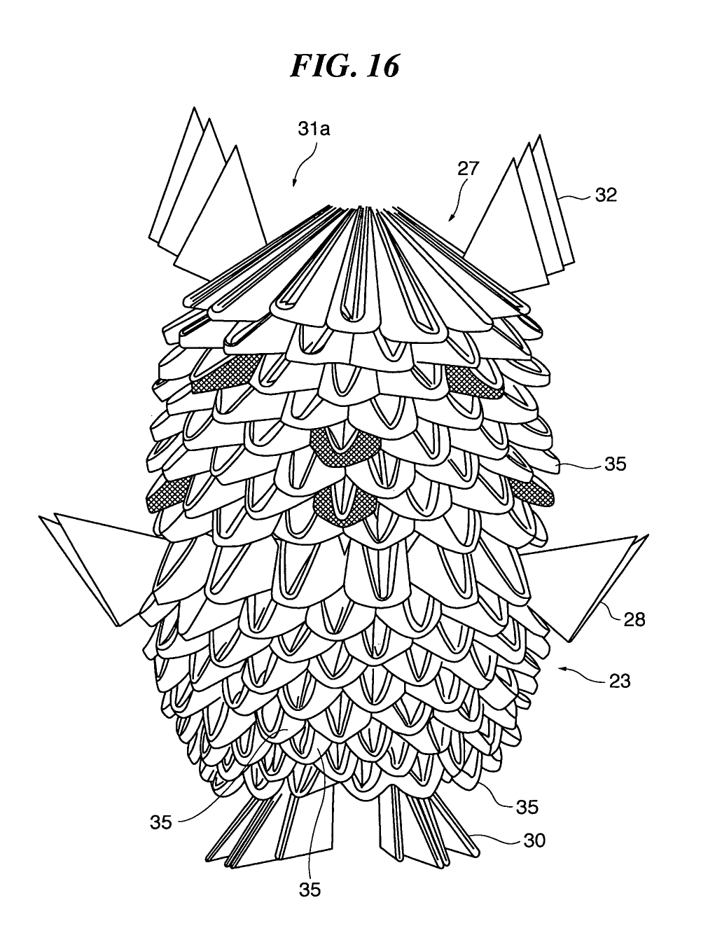

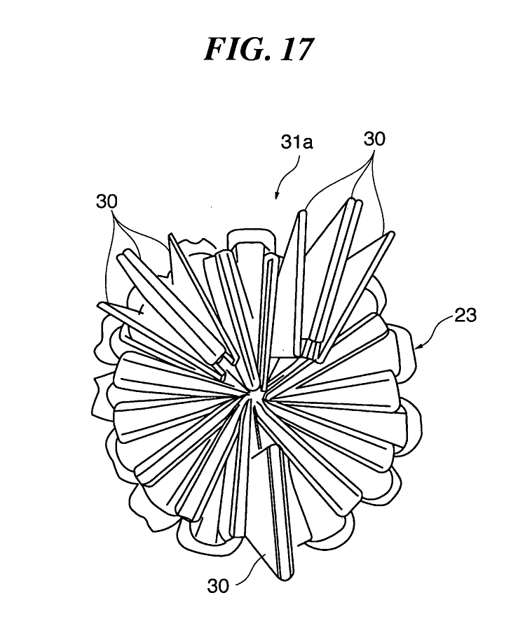

Further, when forming each of the arms 28 at the body part 23, a soft plastic “origami” block 9 is folded into two and inserted at one of its three corner parts into the space between horizontally adjoining soft plastic “origami” blocks 9 at the side of the body part 23 as shown in FIG. 13 (in the illustrated case, so that the insert slot 4 faces upward).

Further, when desiring to make components such as arms (or wings) 28 or a tail, it is possible to successively insert the insert legs 3 of blocks into the insert slots 4 of preceding blocks to form arc shapes and insert ends of these into suitable locations of the body part 23.

Note that in addition to the above construct, for example, the body part 23 may be laid horizontal and the rings 25 increased to lengthen the part so as to form the body of an animal or other organism, then soft plastic “origami” blocks 9 for arms 28 or legs 30 inserted so as to form an assembly 31 of a stylized representation of another animal etc. Further, the blocks may be otherwise suitably assembled to form various assemblies 31.

Note that when using soft plastic “origami” blocks 9, it is also possible to use an adhesive at their front ends to fasten them and thereby improve the shape stability of the plastic “origami” block assembly 31. For example, when forming the body part 23, if inserting the inserts 14 of the soft plastic “origami” blocks 9 into the insert slots 4 in the state with the inserts 14 coated with an adhesive, it is possible to increase the integrity and obtain a stable shaped soft plastic “origami” block assembly 31.

Further, when working the present invention, if using semitransparent soft plastic “origami” blocks 9 and making the rings 25 large in diameter to form a semitransparent soft plastic “origami” block assembly 31 with a hollow inside and inserting a small light bulb inside, the assembly can be utilized as interior décor with an inside lighting effect.

In the above way, the soft plastic “origami” blocks 9 of the present invention require creativity in regards to the selection of colors of the soft plastic “origami” blocks 9 and the constructs assembled from these, that is, color coordination and three-dimensional design ideas, and therefore can be utilized as training tools or educational tools for stimulating human creativity. The obtained soft plastic “origami” block assemblies can be given a level of beauty not achievable with paper. Further, since the folding work such as with paper can be eliminated and assembly work can be immediately commenced, time can be effectively spent on the design of the construct. In addition, since the “origami” blocks 9 are made of soft plastic, they are more wear resistant than paper. Similarly, the completed soft plastic “origami” block assemblies 31 more wear resistant compared with paper “origami” block assemblies 31a and have sufficient durability.

Further, in the case of rectangular shape origami paper, sharp corner parts are formed, but with the soft plastic “origami” blocks of the present invention, it is easy to form rounded corners at the time of cutting and melt fusion.

Note that if making the inside surface of either of the soft plastic first sheet 1 or the soft plastic second sheet 2 a finely pebbled rough surface, the releasability of the sheets 1 and 2 can be improved and the insert legs 3 or inserts 14 can be more easily inserted into the insert slots 4. Further, if using an adhesive, the bonds can be made further reliable.

Note that the angle of the front ends of the cutting edges of the cutting and melt fusing blades 20, while depending on the thicknesses of the soft plastic first sheet 1 and soft plastic second sheet 2 and the widths of the melt fused parts, for example, is made an angle from the center axial line of 10° at the outsides of the soft plastic “origami” blocks 9 since melt fusion is not required there and an angle of 30° at the insides of the soft plastic “origami” blocks 9. Sharp cutting and melt fusing blades with a front end angle of about 40 degrees may be used. Such cutting and melt fusing blades 20 should be provided at the cutting and melt fusing die 21.

While the invention has been described with reference to specific embodiments chosen for purpose of illustration, it should be apparent that numerous modifications could be made thereto by those skilled in the art without departing from the basic concept and scope of the invention.

What is claimed is:

1. A soft plastic “origami” block comprised of an isosceles triangle shaped soft plastic first sheet on one surface of which two isosceles triangle shaped soft plastic second sheets are symmetrically arranged across a vertical bisector of a bottom side of the soft plastic first sheet, wherein outer edges of said soft plastic second sheets are melt fused to outer edges of said soft plastic first sheet, the outer surfaces of the two soft plastic second sheets and soft plastic first sheet form two tapered insert legs and the insides form tapered insert slots smaller than said insert legs, and the remaining not melt fused single sides of the two soft plastic second sheets and said soft plastic first sheet form an insert opening connecting to said insert slots.

2. A soft plastic “origami” block as set forth in claim 1, wherein said insert slots are provided shaped corresponding to said insert legs.

3. A method of production of soft plastic “origami” blocks comprising providing a soft plastic second strip-shaped sheet with separated or separable vertical direction cuts and horizontal direction cuts perpendicularly inserting the same forming boundary parts of soft plastic second sheets, overlaying on the soft plastic second strip-shaped sheet a soft plastic first strip-shaped sheet, and, in that state, cutting and melt fusing the soft plastic strip-shaped second sheet and soft plastic strip-shaped first sheet by a cutting and melt fusing die so that the said vertical direction cuts and horizontal direction cuts become the positions of the vertical bisectors of isosceles triangle shaped blocks.

4. A soft plastic “origami” block assembly assembled using a large number of soft plastic blocks of claim 1.
